(19) United States
(12) Patent Application Publication
(10) Pub. No.: US 2026/0240358 A1
(43) Pub. Date: Aug. 20, 2026

(54) SYSTEM FOR PREPARING AROMATIC BEVERAGES, SUCH AS FOR EXAMPLE TEA

(71) Applicant: NOVADELTA - COMÉRCIO E INDÚSTRIA DE CAFÉS, LDA, Lisboa (PT)

(72) Inventors: Rui Miguel NABEIRO, Campo Maior (PT); João André DE FIGUEIREDO BRANCO, Moscavide (PT)

(73) Assignee: NOVADELTA - COMÉRCIO E INDÚSTRIA DE CAFÉS, LDA, Lisboa (PT)

(21) Appl. No.: 17/429,180

(22) PCT Filed: Feb. 6, 2020
(86) PCT No.: PCT/PT2020/050007

§ 371 Date: Aug. 6, 2021

(30) Foreign Application Priority Data
Feb. 8, 2019 (PT) 115303

(51) Int. Cl. A47J 31/41; A47J 31/44; A47J 31/46

(52) U.S. Cl. CPC A47J 31/41; A47J 31/4435; A47J 31/461; A47J 31/468

(57) ABSTRACT

A system for preparing aromatic beverages, such as for example, tea, including an apparatus (1) presenting a top surface that having a recipient placement disposition (9) adapted for placing a preparation fluid recipient (11, 11′), and a service region adapted so that provides space for placing a plurality of drinking recipients (10, 10′). The apparatus (1) presents a height (H) that is at least four time smaller than any of the other two characteristic dimensions (D2, D3) and the top surface extends devoid of any projection or cavity in an area at least approximately similar to the area of the base region and bigger than the area of the frontal, posterior and side surfaces.

### FIELD OF THE INVENTION

The present invention refers to the field of systems for preparing aromatic beverages by means of infusion of a respective precursor substance, in particular systems with fluid discharge means to the interior of a fluid recipient along a direction opposite to the direction of the gravity force.

### BACKGROUND OF THE INVENTION

In the prior art there are known beverage preparation machines that present fluid recipients for beverage preparation, for example water, for infusion of a respective beverage precursor substance. Said recipients can be provided as reservoirs that supply fluid to an infusion device, such as for example in the case of drip coffee machines, or be provided as recipients where the infusion of beverage precursor substance unfolds, such as for example in the case of teapots for preparing tea. Said machines present different recipient placement dispositions of supply of beverage preparation fluid.

Moreover, the prior art includes several beverage preparation machines with beverage discharge in a direction opposite to the one of the gravity force, that is, through the base region of drinking recipients, such as for example cups. Said machines present recipient placement dispositions including beverage discharge device and adapted for operative retention of the drinking recipient.

In particular in the case of aromatic beverages such as for example coffee or tea, the beverage discharge is a relevant process with potential impact upon the beverage quality obtained in the drinking recipient. In fact, the main characteristics of the discharge flow determine several aspects such as the eventual premature cooling of the beverage as a result of exposure thereof to air during the discharge to a cup, or other beverage drinking recipient.

The prior art includes several examples of relative disposition of these types recipients, of beverage preparation fluid and of beverage, in a beverage preparation apparatus.

The document DE 2009 048233 A1 discloses a system of the type of the present invention whereby portions of edible substance are provided to a collection space and the beverage discharge unfolds along a direction opposite to the gravity force. In particular, the document discloses an apparatus that includes a placement disposition of preparation fluid recipient that in this case is provided as a capsule with a shape and dimension at least approximately to the capsule that contains the edible substance. Moreover, the discharge of the preparation fluid from a respective recipient is carried out at a level similar to the one of injection thereof into the capsule that contains the edible substance, but clearly below the level of beverage discharge into a drinking recipient.

The document WO 2014/086915 A1 discloses a similar system whereby there seems to be an opening for introducing a portion of edible substance and a beverage discharge provided at a similar height. However, the document does not disclose placement dispositions of preparation fluid and beverage recipients, at at least approximately similar levels on the apparatus.

The document WO 2015/084203 A1 filed by the author of the present application discloses a system for preparing aromatic beverages with particularly small configuration and dimensions, so that provides advantages in terms of portability of the apparatus.

The document WO 2017/200409 A1 also filed by the author of the present application discloses a system for preparing aromatic beverages with an optimized beverage discharge disposition and also presenting advantageous a configurations of the apparatus.

### General Description of the Invention

The objective of the present invention is to provide a beverage preparation system, in particular based upon the infusion of a respective precursor substance, including a beverage preparation apparatus that presents first and second recipient placement dispositions configured so that drinking and beverage preparation recipients can be placed thereupon, respectively, said system being adapted so as to provide a general configuration that is more compact and, specially, of more planar shape, as a sort of cup tray, adapted to the placement of said recipients and to the general ergonomic of use of said apparatus, notably in terms of portability thereof.

This objective is solved according to the present invention by means of a system for distribution of edible products according to claim 1.

In particular, the objective above is solved by means of a beverage preparation system including at least one type of beverage preparation recipient configured for collecting a fluid and an edible substance to be used in the preparation of a beverage, such as for example a teapot-like or coffeepot-like recipient, and further including a beverage preparation apparatus that presents: a first recipient placement disposition adapted so that provides placement surface to a plurality of drinking recipients, such as for example a tea cup, and a second recipient placement disposition adapted so that provides operative placement of at least one type of beverage preparation fluid recipient, whereby said beverage preparation recipient is configured so that can collect said beverage preparation fluid, through a base region thereof, in the form of a pressurized flow at a previously defined flow pressure at least bigger than the atmospheric pressure, and that can receive said edible substance through an opening provided on a region other than the base region.

An associated objective is to disclose a relative disposition of components and configuration of apparatus that minimizes the constructive height necessary to accommodate the fluid circulation between a fluid Supply recipient and the beverage discharge to the beverage preparation recipient, in particular with a total height that is smaller than any of the remaining characteristic dimensions, on an apparatus whereby the fluid discharge for beverage preparation to the interior of a respective beverage preparation recipient, is carried out in a direction contrary to the direction of the gravity force.

In particular, said drinking recipient is understood as the recipient used for final consumption of the beverage, such as for example of glass, cup or similar type. Said beverage preparation recipient is understood as a recipient configured for collecting a quantity of the fluid used in a mixture, for example of the infusion type, or added to another fluid so as to prepare a beverage, and generally corresponding to the quantity required for preparing a plurality of individual beverage portions for final consumption.

It is preferred when said apparatus is adapted for preparation of beverages by infusion, in particular of aromatic beverages such as tea or coffee, based upon the interaction between a beverage preparation fluid with a corresponding portion of beverage precursor substance inside of said beverage preparation recipient.

It is preferred when said apparatus presents an access disposition provided in a general shape of lid type or similar, and adapted so that can selectively cover at least one of, preferentially both, said first and second recipient placement dispositions, and when said access disposition is provided in one piece or in a plurality of pieces, and configured so that can selectively cover both of said recipient placement dispositions jointly and/or individually It is preferred when said apparatus comprises a fluid reservoir provided in flow connection with a fluid pressurization device and with the fluid discharge element on said second recipient placement disposition.

It is further preferred when said top part of said apparatus only presents said first and second recipient placement dispositions, and is preferentially devoid of any other cavities or protuberances.

It is preferred when the system according to the present invention further comprises portions of edible substance, for example tea or coffee, provided so that can be introduced on said beverage preparation recipient.

### DESCRIPTION OF THE FIGURES

The invention shall be hereinafter described in greater detail based upon preferred embodiments and on the attached Figures.

The Figures show, in simplified schematic representations:

FIG. 1: front and top views (on the right-hand side) of an embodiment of a system according to the present invention, whereby the apparatus (1) presents the access disposition (4) in a closed position;

FIG. 2: views of the embodiment according to FIG. 1, whereby the apparatus (1) presents the access disposition (4) in a removed condition;

FIG. 3: side view of a second embodiment according to FIG. 1, with the access disposition (4) removed and the drinking (9) and fluid recipients (11) placed;

FIG. 4: top view according to FIG. 3;

FIG. 5: side view of a third embodiment, with the access disposition (4) removed and the drinking (9) and fluid (11) recipients not placed;

FIG. 6: top view according to FIG. 5.

### DETAILED DESCRIPTION OF PREFERRED EMBODIMENTS OF THE INVENTION

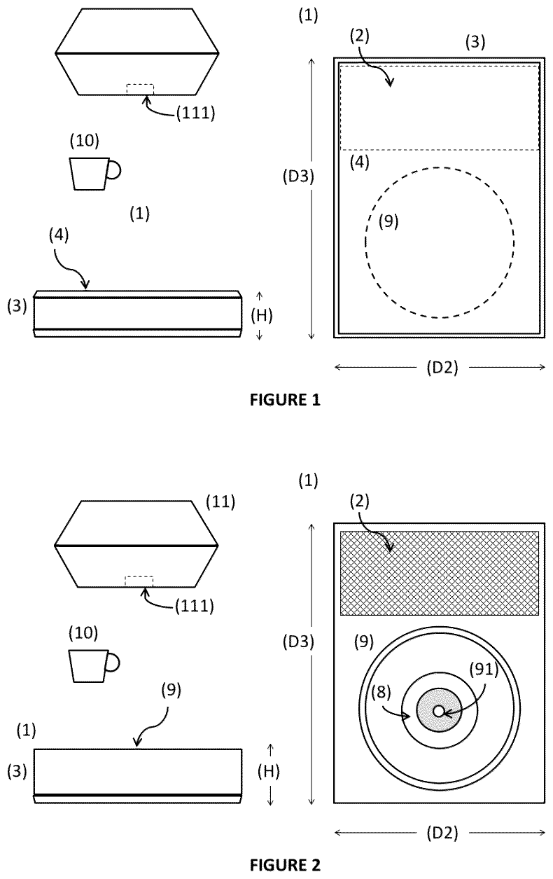

FIGS. 1 and 2 represent a first embodiment of a system according to the present invention.

Said system basically includes a beverage preparation apparatus (1), drinking recipients (10, 10′) and beverage preparation recipients (11, 11′) presenting a collection space of a fluid volume for beverage preparation, for example water. Said system can further comprises previously produced portions of edible substance.

The apparatus (1) can present a first recipient placement disposition (2) on the top region of the apparatus envelope (3) and configured so that provides the placement of a plurality of drinking recipients (10, 10′). Said first recipient placement disposition (2) can be provided non-aligned with a beverage discharge line directly from the beverage preparation recipient (11, 11′). As represented, the drinking recipient (10) can be in the form of a cup of tea, or similar.

Said apparatus (1) further presents a second recipient placement disposition (9) adapted So that provides the placement, particularly preferentially with removable retention, of at least one type of beverage preparation recipient (11, 11′). In the case of the represented embodiment, said beverage preparation recipient (11, 11′) is provided in the form of a thermal recipient adapted so as to mitigate the heat loss through the respective envelope.

According to an inventive aspect, said beverage preparation recipient (11, 11′) presents a base region adapted so that can receive a fluid flow (FS), and preferentially also a heat flux, when placed on the operative retention position on said second recipient placement disposition (9).

In particular, said beverage preparation recipient (11, 11′) presents a flow regulation element (111, 111′) on the base region, adapted so that only provides flow passageway when the flow pressure is bigger than a previously defined value. It is preferred when said flow pressure is bigger than the atmospheric pressure, preferentially bigger than 1,2 bar, and smaller than 5 bar, preferentially smaller than 3 bar. This flow regulation element can be, for example, of single-way valve type (111) or plurality of micro-holes (111′) with an appropriate characteristic dimensions. These means are known in the prior art such one herewith abdicates of a more detailed representation or description thereof.

Moreover, as represented in FIG. 2, it is preferred when the base surface associated with said second recipient placement disposition (9) presents a heating device (8), configured so that can provide a heating power through the base of the beverage preparation recipient (11, 11′). The base of said recipient (11, 11′) is adapted in corresponding manner, so as to promote heat transfer to the fluid inside, for example through a thermally conducting material.

It is preferred when the apparatus (1) provides an indication to the user, for example of haptic type, visual or acoustic signal, when the beverage preparation recipient (11, 11′) is correctly retained on said operative retention position, and can thereby provide a flow connection through the base region, liquid sealed with respect to the vicinity thereof.

According to an inventive aspect, said first and second recipient placement dispositions (2, 9), in particular at least the base region thereof, are advantageously provided at a level at least approximately similar of said apparatus (1).

Moreover, in the case of the represented embodiment, the first and second recipient placement dispositions (2, 9) are both provided at a level closer to the base region than to the top region of said apparatus (1). This relative disposition advantageously provides a smaller construction height of the apparatus for accommodating the several components of fluid circulation between the beverage preparation recipient (11) and the drinking recipient (10).

As further represents in FIGS. 1 and 2, the apparatus (1) in this case presents an apparatus envelope (3) and an access disposition (4) that jointly define, at least substantially, the volume geometry of the apparatus (1), in particular a coherent geometry that in this case at least approximately corresponds to a cube.

Advantageously, said access disposition (4) provides selective access to said recipient placement disposition (2) and product discharge (21), so that prevents the possibility of accumulation of dusts and other residues as a result of exposure to environmental at a given location of use of the apparatus (1).

It is particularly preferred, when the recipient placement disposition (2), and respective product discharge, is herewith selectively confined with respect to the exterior the apparatus (1), so that the possibility of contamination thereof is mitigated.

Moreover, said apparatus envelope (3) and access disposition (4) jointly define a material volumetric that is preferentially substantially continuous, devoid of projections or cavities.

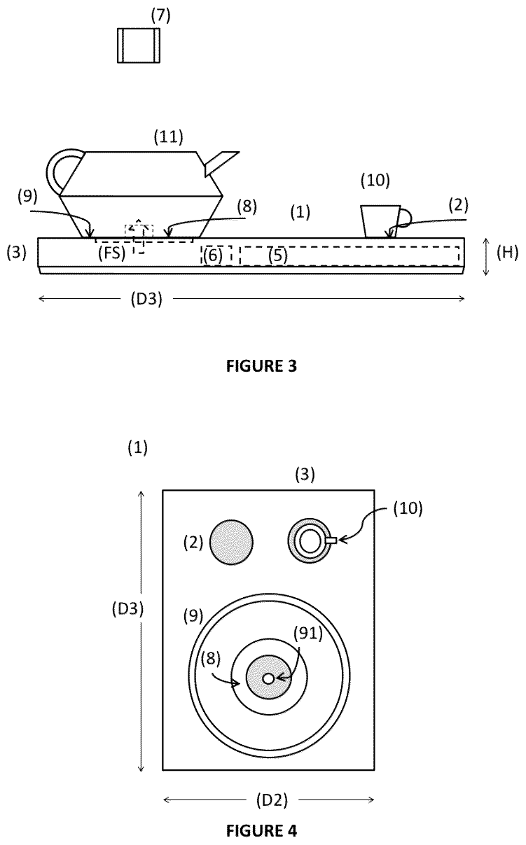

FIGS. 3 and 4 represent a second embodiment according to the present invention, whereby the apparatus (1) according to the present invention presents an apparatus envelope (3) with a general shape of a tray board type, thereby improving the general ergonomic of use thereof.

The beverage preparation apparatus (1) comprises a second recipient placement disposition (9) that presents a fluid injection element (91) and is adapted for placement of at least one type of beverage preparation recipient (11, 11′) , on an operative retention position SO that said fluid injection element (91) is substantially aligned with a fluid discharge element (111, 111′) , for example of type single-way valve or similar. Said fluid injection element (91) can be adapted so as to engage in shape with said flow regulation element (111, 111′) when said beverage preparation recipient (11, 11′) is on said operative retention position.

Said beverage preparation recipient (11, 11′) can in this case be of the coffee pot type, or tea pot, presenting a base region adapted so that can be retained in removable manner on said second recipient placement disposition (9). In particular, the base region can present an element of single-way valve type, or similar, adapted so that only enables fluid injection and/or discharge when impinged by a flow pressure bigger than 1 bar, preferentially bigger than 1,2 bar, for example of 2 or 3 bar, or bigger. The beverage preparation apparatus (1) comprises for this purpose a flow pressurization device, of pump type, adapted so that can generate an hydraulic pressure and/or a sub-pressure on the flow circulation line between said first and second recipient placement dispositions (2, 9).

The apparatus (1) can comprise a fluid reservoir (5), for example for storing water, provided inside of the apparatus envelope (3) and at a level below said first and second recipient placement dispositions (2, 9). Said fluid reservoir (5) is provided in flow connection with a flow pressurization device (6), for example of hydraulic pump type, or similar, and with said fluid injection element (91).

The portion (7) of edible substance used in the beverage preparation, for example a sachet of aromatic herbs, can be supplied to said beverage preparation recipient (11, 11′) through an opening provided on top thereof.

As further represented in FIGS. 3 and 4, according to a particularly advantageous aspect of the present invention, the system comprises a beverage preparation apparatus (1) that is configured so that, in case the drinking and/or beverage preparation recipients (10, 11) are not placed on respective placement dispositions (2, 9), is devoid of cavities and projections, at least in the top surface thereof, preferentially also in the front, posterior and lateral surfaces.

Moreover, according to another particularly advantageous aspect of the present invention, the system comprises an apparatus (1) that is configures so that the height (H) thereof is much smaller, preferentially at least four times smaller than any of its other characteristic dimensions (D2, D3), particularly preferentially at least ten times smaller than the biggest of the other two characteristic dimensions (D2, D3).

It is preferred when said height (H) corresponds to the single height that at which extends the top surface of said apparatus (1), whereby this top surface can be provided by at least one of said apparatus envelope (3) and said access disposition (4).

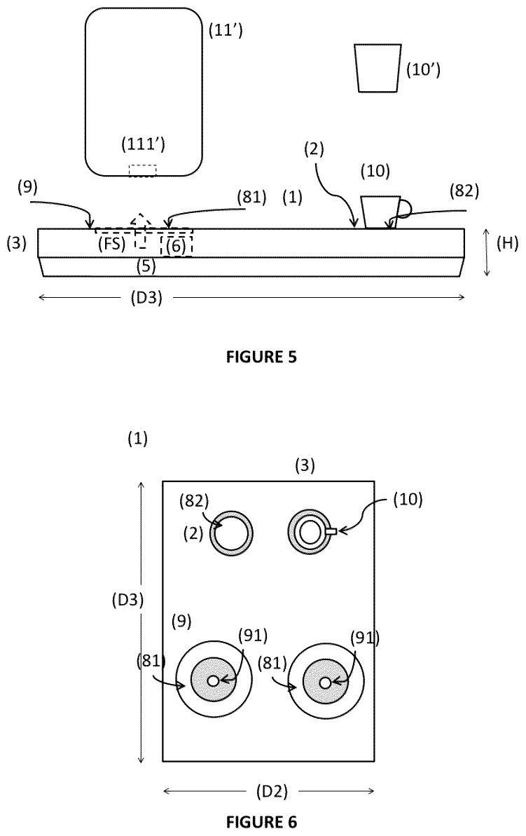

FIGS. 5 and 6 represent another embodiment of similar configuration to the previous one, and that presents a plurality of units, in this case two, of both of said first and second recipient placement dispositions (2, 9).

The beverage preparation recipients (11′) can in this case be configured so that can collect fluid for preparing a beverage, for example milk, or a previously prepared beverage, for example soluble coffee, so that can selectively supply a respective flow to at least one of two drinking recipients (10, 10′) for final consumption by a user, provided in respective units of said first recipient placement disposition (2).

The preparation reservoir (5) is in this case configured so that extends in the entire extension of width and length of the base region of the apparatus (1).

Said apparatus (1), in particular said apparatus envelope (3), preferentially configures jointly at least with the fluid reservoir (5) for beverage preparation, at least approximately the exterior shape and dimensions of said apparatus (1), preferentially corresponding at least approximately to a geometric shape of regular volume, providing a substantially continuous exterior surface substantially devoid of protuberances or cavities. Moreover, said apparatus (1), in particular said apparatus envelope (3) thereof, presents a top region extending in materially continuous manner along a single plane and with an area dimension that is bigger than the sum of the area of the lateral, front and top regions of said apparatus envelope (3).

Said apparatus (1), in particular said apparatus envelope (3) thereof, presents a first dimension, preferentially the height (H), of apparatus (1) that is at most 50%, preferentially at most 30%, particularly preferentially at most 15%, of at least a second characteristic dimension (D2) thereof, preferentially also of a third characteristic dimension (D3) thereof.

1. A system for preparing beverages, in particular based upon infusion of a respective precursor substance, including at least one type of beverage preparation recipient (11, 11′) configured for collection of a fluid for infusion of the precursor substance, and further including a beverage preparation apparatus (1) that presents:
a first recipient placement disposition (2) adapted so that provides placement surface for a drinking recipient (10, 10′),
a second recipient placement disposition (9) adapted so that provides operative placement of at least one type of beverage preparation recipient (11, 11′), configured for collection of the precursor substance and for preparing a beverage,
wherein
said beverage preparation recipient (11, 11′) is configured so that can receive pressurized flow through a base region thereof, and that can receive said precursor substance through an opening provided on a region different from the base region of said beverage preparation recipient (11, 11′).

2. The system according to claim 1, wherein said second recipient placement disposition (9) presents a fluid injection element (91) adapted so that can inject a pressurized flow into said beverage preparation recipient (11, 11′) through a portion base thereof.

3. The system according to claim 1, wherein
said second recipient placement disposition (9) is adapted so that provides removable retention of said beverage preparation recipient (11, 11′) on the apparatus (1), preferentially by means of engagement of mechanical type of a base portion thereof with a portion associated with said second recipient placement disposition (9), so that the fluid injection element (91) is aligned with a flow passageway portion on the base region of said beverage preparation recipient (11, 11′).

4. The system according to claim 1, wherein
said apparatus (1) comprises a fluid circulation device (6), for example a hydraulic pump, downstream from the flow discharge of said second recipient placement disposition (9), said fluid circulation device (6) being adapted so that provides a flow pressure of at most 4 bar, said fluid circulation device (6) being provided upstream and in fluid connection with said second recipient placement disposition (9).

5. The system according to claim 1, wherein
said apparatus (1) comprises a preparation fluid reservoir (5) for beverage preparation, for example water, provided in flow connection upstream of said second recipient placement disposition (9), said preparation fluid reservoir (5) for beverage preparation being provided in the interior of the apparatus envelope (3) or associated with the apparatus envelope (3) of said apparatus (1), preferentially so that configures, jointly with the apparatus envelope (3) a volume of at least approximately regular geometric shape, said preparation fluid reservoir (5) for beverage preparation preferentially presenting a general format at least approximately similar to that of said apparatus envelope (3).

6. The System according to claim 1, wherein
said apparatus (1) comprises a first heating device (81) associated with said second recipient placement disposition (9), and preferentially configured with surface a in contact at least of proximity, with the base region of said beverage preparation recipient (11, 11′), whereby said first heating device (81) is adapted so that can heat up the fluid volume contained on said beverage preparation recipient (11, 11′) to a fluid temperature of at least 40° C., preferentially of at least 60° C., and at most 100° C.

7. The system according to claim 1, wherein
said apparatus (1) comprises a second heating device (82) associated with said first recipient placement disposition (2) and preferentially configured as a surface in contact at least of proximity with the base region of said drinking recipient (10, 10′), whereby said second heating device (82) is adapted so that can provide a heating temperature of at least 30° C., preferentially of at least 40° C., and at most 50° C.

8. The system according to claim 1, wherein
said first and second recipient placement dispositions (2, 9), in particular at least the base region thereof, are provided at a level at least approximately similar on said apparatus (1), preferentially are both provided on the top region of said apparatus (1).

9. The system according to claim 1, wherein
said beverage preparation recipient (11, 11′) is configured so that provides a fluid collection volume at least two times bigger, preferentially at least four times bigger than the collection volume provided by said drinking recipient (10, 10′).

10. The system according to claim 1, wherein
said beverage preparation recipient (11, 11′) presents a flow regulation element (111, 111′), including for example of the type single-way valve, disposed in the base region thereof and adapted so that only provides flow passageway in case impinged with a previously defined flow pressure, preferentially with a flow pressure bigger than the atmospheric pressure and smaller than 5 bar, and preferentially further presents a beverage discharge element provided on another wall, different from the base wall of said beverage preparation recipient (11, 11′).

11. The system according to claim 1, wherein
said system includes portions (7) of precursor substances in respective enclosure, such as for example tea bags, adapted so that can be introduced in said beverage preparation recipient (11).

12. The System according to claim 1, wherein
said apparatus (1) is configured so that presents at least one of the following:
said apparatus (1), in particular the apparatus envelope (3) thereof, at least approximately configures the exterior shape and exterior dimensions of said apparatus (1), preferentially jointly at least with the fluid reservoir (5) for beverage preparation, preferentially at least approximately corresponding to a volume of regular geometric shape, providing a substantially continuous exterior surface devoid of protuberances or cavities, and
said apparatus (1), in particular the apparatus envelope (3) thereof, presents a top region extending in materially continuous manner along a single plane and with an area dimension bigger than the sum of area dimension of the lateral, frontal and top regions of said apparatus envelope (3), and
said apparatus (1), in particular the apparatus envelope (3) thereof, presents a first dimension, preferentially the height (H) of apparatus (1) that is at most 50%, preferentially at most 30%, particularly preferentially at most 15%, of at least a second characteristic (D2) thereof, preferentially also of a third characteristic (D3) thereof.

13. The system according to claim 1, wherein
said apparatus (1) further presents at least one access disposition (4) adapted so that can be manually and/or mechanically actuated and thereby provide selective access at least to said second recipient placement disposition (9), preferentially also to said first recipient placement disposition (2), whereby said access disposition (4) preferentially presents a shape of planar type and not presenting any protuberance, cavity or opening, whereby at least two of said apparatus envelope (3), access disposition (4) and fluid reservoir (5), jointly provide at least most part, preferentially the totality of the material exterior envelope of said apparatus (1), and jointly at least approximately configure the exterior volumetric shape of said apparatus (1) that preferentially corresponds to at least part of a coherent geometry.

14. The system according to claim 13, wherein
in that in case the access disposition (4) is in the closed position, said apparatus envelope (3) and access disposition (4) jointly define a volume devoid of any fluid discharge (91) exposed to the exterior of said apparatus (1), whereby said apparatus envelope (3) and access disposition (4) preferentially jointly define a materially continuous surface along at least most part of the extension of the exterior surface at least of the top, frontal and posterior portions of said apparatus (1), preferentially also of the lateral portions thereof.

15. The system according to claim 13, characterized
in that said access disposition (4) presents a first and a second actionable parts configured so that can be moved with relation to the apparatus envelope (3), whereby the actuation of at least one of said first and second actionable parts can be carried out in at least one of: together with, and autonomously relative to the other actionable part.

16. The system according to claim 13, characterized
in that said access disposition (4) is provided with at least one of: total dimension and dimension of the actuation space that corresponds to at least half, preferentially more than half, particularly preferentially at least approximately one of the characteristic dimensions (D2, D3) of the top region of said apparatus envelope (3).
